(19) United States
(12) Patent Application Publication
(10) Pub. No.: US 2015/0110971 A1
(43) Pub. Date: Apr. 23, 2015

(54) Composite electrodes for lithium ion battery and method of making

(71) Applicant: QuantumScape Corporation, San Jose, CA (US)

(72) Inventor: Isaiah O. Oladeji, Gotha, FL (US)

(21) Appl. No.: 14/121,320

(22) Filed: Aug. 19, 2014

Related U.S. Application Data
(63) Continuation of application No. 13/317,973, filed on Nov. 1, 2011, now abandoned.

(51) Int. Cl. H01M 4/1391; H01M 4/04

(52) U.S. Cl. CPC H01M 4/1391; H01M 4/0471; H01M 4/0435; H01M 4/0416; H01M 2004/028
USPC 427/565; 427/58

(57) ABSTRACT

A method for making a composite electrode for a lithium ion battery comprises the steps of: preparing a slurry containing particles of inorganic electrode material(s) suspended in a solvent; preheating a porous metallic substrate; loading the metallic substrate with the slurry; baking the loaded substrate at a first temperature; curing the baked substrate at a second temperature sufficient to form a desired nanocrystalline material within the pores of the substrate; calendaring the cured composite to reduce internal porosity; and, annealing the calendared composite at a third temperature to produce a self-supporting multiphase electrode. Because of the calendaring step, the resulting electrode is self-supporting, has improved current collecting properties, and improved cycling lifetime. Anodes and cathodes made by the process, and batteries using them, are also disclosed.

### CROSS-REFERENCE TO RELATED APPLICATION

This application is a Continuation of U.S. patent application Ser. No. 13/317,973 entitled “Composite Electrodes for Lithium Ion Battery and Method of Making”, filed on Nov. 1, 2011, and is also related to U.S. patent application Ser. No. 13/317,963 entitled, “Composite Electrodes for Lithium Ion Battery and Method of Making” filed on Nov. 1, 2011, by the present inventor, the entire disclosures of which are incorporated herein by reference.

### BACKGROUND OF THE INVENTION

1. Field of the Invention

The invention pertains to methods of making composite electrodes for lithium ion batteries, and more particularly, to methods of fabricating composite cathodes suitable for both liquid cell and all-solid-state cell applications, and batteries containing the same.

2. Description of Related Art

Electrodes, especially the cathodes, for traditional lithium ion batteries are typically multi-component structures. They include: nanoparticles of the active cathode material for lithium storage; an electron conductor that is either carbon black, carbon nanotube, carbon fiber, or graphene; a binding agent that is an insulating polymer that binds all the nanoparticles to each other and to a substrate; and an ionic conductor that is usually provided by forming the film of the composite of other components deposited on a metallic current collector foil and then soaking in a liquid electrolyte.

The active material nanoparticles as well as the nanoparticles of conductive carbonaceous materials are preformed. To improve the cell performance, researchers over the years have worked on size distribution of the nanoparticles, doping of the active material nanoparticles with other elements, and coating the active material nanoparticles with an electronic conductor film or an ionic conductor film. Several of these methods as previously disclosed include:

U.S. Pat. No. 7,608,362 describes a method of producing a composite cathode active material powder comprising at least one large diameter active material selected from the group consisting of metal composite oxides and at least one small diameter active material selected from the group consisting of carbon-based materials and metal oxide compounds. Mixing the large and small diameter active materials in a proper weight ratio improves packing density; and including highly stable materials and highly conductive materials in the composite cathode active materials improves volume density, discharge capacity and high rate discharge capacity. The large diameter active material is selected from the group consisting of compounds LiₓCo_{1-y}M_{y}O_{2-α}X_{α} and LiₓCo_{1-y-z}Ni_{y}M_{z}O_{2-α}X_{α}, and at least one small diameter active material is selected from the group consisting of compounds represented by LiₓCo_{1-y-z}Ni_{y}M_{z}O_{2-α}X_{α}, LiₓMn_{2-y}M_{y}O_{4-α}X_{α}, and LiₓCo_{2-y}M_{y}O_{4-α}X_{α}, Where M is selected from the group consisting of Al, Ni, Mn, Cr, Fe, Mg, Sr, V, rare earth elements and mixtures thereof, and X is selected from the group consisting of O, F, S, P, and combinations thereof, and carbon-based material. The carbon-based material may be selected from the group consisting of graphite, hard carbon, carbon black, carbon fiber, carbon nanotubes (CNT) and mixtures thereof.

U.S. Pat. No. 7,842,420 describes a method of fabricating powder of cathode material from a starting mixture which includes a metal, a phosphate ion, and an additive which enhances the transport of lithium ions in the resultant material. The cathode material comprises LiₓMPO₄ wherein M is metal such as iron, and x ranges from 0 upwards to approximately 1, and the additive is selected from the group consisting of: V, Nb, Mo, C, and combinations thereof. The additive may function as a nucleating agent which promotes the growth of at least one component of the material. In still other instances, the additive may promote the reduction of a carbon-containing species in the starting mixture so as to generate free carbon, and this free carbon may be at least partially sp² bonded. In yet other instances, the additive is operative to modify the lattice structure of the material so that the transport of lithium ions through the modified lattice is enhanced in relation to the transport of lithium ions through a corresponding unmodified lattice. The mixture is heated in a reducing environment to produce the material then ball milled to produce the powder. Heating may be carried out in a temperature range of 300-750° C.

U.S. Pat. No. 7,396,614 describes a method of fabricating a composite positive electrode material comprising a non agglomerating lithium vanadium oxide particles, of the form Li₁₊ₓV₃O₈ in which 0.1≦x≦0.25, as active material, a carbon black material which confers electron conduction properties to the electrode, and a mixture of lithium salt and organic binder which confers ionic conduction properties and mechanical properties to the electrode. The composite positive electrode can be prepared by mixing the active material and the carbon black in a solution of the binder and lithium salt in an appropriate solvent and then by evaporating the solvent under hot conditions under a nitrogen atmosphere. The process for the preparation of the active compound consists in reacting at least one Li precursor with at least one vanadium precursor. The lithium precursor can be chosen from lithium oxides such as Li₂CO₃, LiNO₃, LiOH, LiOH.H₂O and Li₂O and organic lithium salts, such as lithium acetylacetonate, lithium acetate, lithium stearate, lithium formate, lithium oxalate, lithium citrate, lithium lactate, lithium tartrate or lithium pyruvate. The vanadium precursor can be chosen from vanadium salts and vanadium oxides such as α-V₂O₅, NH₄VO₃, V₂O₄ and V₂O₃.

U.S. Pat. No. 7,923,154 describes a method of synthesis of carbon-coated powders having the olivine or NASICON structure. Carbon-coating of the powder particles is necessary to achieve good performances because of the rather poor electronic conductivity of NASICON structures. For the preparation of coated LiFePO₄, sources of Li, Fe and phosphate are dissolved in an aqueous solution together with a polycarboxylic acid and a polyhydric alcohol. Upon water evaporation, polyesterification occurs while a mixed precipitate is formed containing Li, Fe and phosphate. The resin-encapsulated mixture is then heat treated at 700° C. in a reducing atmosphere to produce a fine powder consisting of an olivine LiFePO₄ phase, coated with conductive carbon. This powder is used as active material in a lithium insertion-type electrode.

U.S. Pat. No. 7,892,676 describes a method of producing a cathode material comprising a composite compound having a formula of A₃ₓM1_{2y}(PO₄)₃, and a conductive metal oxide having a formula of M2ₐO_{b}, wherein A represents a metal element selected from the group consisting of Groups IA, IIA and IIIA; each of M1 and M2 independently represents a metal element selected from the group consisting of Groups IIA and IIIA, and transition elements. The cathode material is prepared by the following steps: preparing a solution including A ion, M1 ion, and PO₄³⁻; adding M2 salt into the solution; adjusting the pH of the solution so as to form M2 hydroxide and to convert M2 hydroxide into M2 oxide; and heating the solution containing M2 oxide so as to form the cathode material with fine particles of M2 oxide dispersed in an aggregation of particles of A₃ₓM1_{2y}(PO₄)₃.

U.S. Pat. No. 7,939,198 describes a method to produce a composite cathode comprising an electroactive sulfur-containing cathode material that comprises a polysulfide moiety of the formula —Sₘ—, wherein m is an integer equal to or greater than 3; and an electroactive transition metal chalcogenide having the formula MⱼYₖ(OR)ₗ wherein: M is a transition metal; Y is the same or different at each occurrence and is oxygen, sulfur, or selenium; R is an organic group and is the same or different at each occurrence; j is an integer ranging from 1 to 12; k is a number ranging from 0 to 72; and l is a number ranging from 0 to 72; with the proviso that k and l cannot both be 0. The chalcogenide encapsulates the electroactive sulfur-containing cathode material and retards the transport of anionic reduction products of the electroactive sulfur-containing cathode material. The method relates to the fabrication of a composite cathode by a sol-gel method wherein the electroactive sulfur-containing cathode material, and optionally binders and conductive fillers, are suspended or dispersed in a medium containing a sol (solution) of the desired electroactive transition metal chalcogenide composition; the resulting composition is first converted into a sol-gel (e.g., a gel-like material having a sol-gel structure or a continuous network-like structure) by the addition of a gelling agent, and the resulting sol-gel is further fabricated into a composite cathode.

All the approaches above still require an organic binder to bind the various nanoparticles together among themselves and to the substrate or current collector. The liquid electrolyte that permeates the cathode made up of lithium storage particles, electron conducting particles, the film of insulative organic binder surrounding the particles, and the voids provides lithium ion conduction. Thus the transport of lithium ion from the liquid and the energy storage particles is limited by the surrounding insulative binder film; this leads to local solid electrolyte interface (SEI) layer formation around the particles because of the side reaction taking place between the liquid electrolyte and organic binder film. The continuous adverse change in the properties of this SEI layers limit the performance and the lifetime of the traditional lithium ion cells.

J. S. Wang et al. [Journal of Power Sources 196:8714-18 (2011)], tried to increase the specific energy density of traditional cells. The cell has a cathode consisting of 1.2 mm thick Al foam filled with a slurry composed of 84 wt. % Li(NiCoMn)_{1/3}O₂ (L333, NCM-01ST-5, Toda Kogyo)+9 wt. % poly(vinylidene fluride-cohexafluropropylene) binder (Kynar Flex 2801, Elf Atochem)+3.5 wt. % carbon black (Super P, MMM)+3.5 wt. % synthetic graphite (KS6, Timcal); an anode, made using 1.2 mm thick Cu foam filled with the slurry of 93 wt % active carbon material (SG, Superior Graphite, SLC 1520), 3 wt. % carbon black (Super P), and 4 wt. % SBR binder (an aqueous styrene-butadiene rubber binder, LHB-108P). The best performance of 10 mAh/cm² was obtained only at low C rate C/50. A rapid fade was observed at C rate as low as C/20. The energy density of the cell is low because of thick electrodes, also the fundamental low cycle life affecting the traditional cell due to SEI layer has not been addressed by this approach.

In recent years, attempts have been made in making binder free and liquid electrolyte free cathodes in cells as reported by the following:

Hayashi, et al. [Journal of Power Sources 183:422-26 (2008)] constructed a laboratory-scale solid-state cell consisting of the composite cathode powder obtained by mixing Li₂S—Cu materials, the lithium ion conductor 80Li₂S.20P₂S₅ glass-ceramic, and electronic conductor acetylene-black with the weight ratio of 38:57:5. The composite powder (10 mg) as a cathode, and the 80Li₂S.20P₂S₅glass-ceramic powder (80 mg) as a solid electrolyte were placed in a polycarbonate tube (with a diameter of 10 mm) and pressed together under 3700 kg/cm², and then an Indium foil as a negative electrode was pressed under 1200 kg/cm² on the pellet. After releasing the pressure, the obtained pellet was sandwiched by two stainless-steel rods as current collectors. The cells were charged and discharged at room temperature in an Ar atmosphere using a charge-discharge measuring device (BTS-2004, Nagano). The constant current density of 64 μA/cm² was used for charging and discharging with the maximum discharge capacity of 490 mA-h/g.

Sakuda et al. [Chem. Mater., Vol. 22, No. 3, 2010] constructed all-solid-state cells as follows. Mixing Li₂SiO₃ coated LiCoO₂ and the 80Li₂S₃-20P₂S₅ glass-ceramic electrolyte with a weight ratio of 70:30 using an agate mortar to prepare composite positive electrodes. A bilayer pellet consisting of the composite positive electrode (10 mg) and glass-ceramic solid electrolytes (80 mg) was obtained by pressing under 360 MPa in a 10 mm diameter tube; indium foil was then attached to the bilayer pellet by pressing under 240 MPa. The pellet was pressed using two stainless steel rods; the stainless steel rods were used as current collectors for both positive and negative electrodes. All the processes for preparation of solid electrolytes and fabrication of all-solid-state batteries were performed in a dry Ar-filled glovebox ([H₂O]<1 ppm). A discharge capacity of 60 mAh/g was obtained at a discharge current density of 64 μA/cm² at 30° C.

Also, Sakuda et al. [Journal of Power Sources 196:6735-41 (2011)]; using the same cell construct described above, used LiCoO₂ composite cathode, where LiCoO₂ was coated with LiNbO₃ then 80Li₂S₃-20P₂S₅ films; these particles where then mixed with 80Li₂S₃-20P₂S₅ particles to form the composite cathode. The resulting best cell was charged/discharged at the current density of 0.13 mA/cm² and gave a discharge capacity of 95 mA-h/g.

Importantly, the LiCoO₂ particle coating was done with Pulse Laser Deposition (PLD), a process that is relatively unsuitable for routine manufacturing. And all the solid state cells were made by pressing the stack of powder of various components into small area cylindrical disk, a cell fabrication technique that is not readily scalable. The mechanical contact between the particles that dependent on pressing pressure provides less than ideal electrical contact between various particles. The latter combined with too thick solid state electrolyte layer in the cell leads to undesirable overall cell impedance that limits the extractable capacity.

What is needed, therefore, is a scalable, efficient process for making composite cathodes for lithium ion batteries that is suitable for use in both liquid cell and all-solid-state cell applications.

Objects and Advantages

Objects of the present invention include the following: providing an improved composite electrode for lithium ion batteries; providing a composite cathode for alkali ion batteries; providing a composite cathode suitable for both liquid cell and all solid state metal ion batteries; providing an improved alkali ion battery; providing methods for fabricating composite electrodes for metal ion batteries; and providing a scalable, manufacturable process for making composite electrodes and batteries containing them. These and other objects and advantages of the invention will become apparent from consideration of the following specification, read in conjunction with the drawings.

### SUMMARY OF THE INVENTION

According to one aspect of the invention, a method for making a composite electrode for a lithium ion battery comprises the steps of:

preparing a slurry containing particles of a selected inorganic electrode material suspended in a selected solvent;

preheating a porous metallic substrate;

loading the preheated metallic substrate with the slurry;

baking the loaded substrate at a first selected temperature;

curing the baked substrate at a second selected temperature sufficient to form a desired nanocrystalline material within the pores of the substrate;

calendaring the cured composite to reduce internal porosity; and,

annealing the calendared composite at a third temperature greater than the second temperature to produce a self-supporting multiphase electrode.

According to another aspect of the invention, a cathode for a lithium ion battery comprises:

a first phase comprising an inorganic energy storage material;

a second phase comprising a solid state lithium ion conductor; and,

a third phase comprising a reticulated metal structure, interspersed throughout the first and second phases, the reticulated metal forming a structural reinforcement and a current collector,

wherein the metal structure comprises from 5 to 25% of the volume of material, the first and second phases together comprise from 75 to 95% of the volume of the material, and the cathode contains no more than 30 vol. % porosity.

According to another aspect of the invention, an anode for a lithium ion battery comprises:

a first phase comprising a lithium ion storage material;

a second phase comprising a solid state lithium ion conductor; and,

a third phase comprising a reticulated metal structure, interspersed throughout the first and second phases, the reticulated metal forming a structural reinforcement and a current collector,

wherein the metal structure comprises from 5 to 25% of the volume of material, the first and second phases together comprise from 75 to 95% of the volume of the material, and the anode contains no more than 30 vol. % porosity.

According to another aspect of the invention lithium ion battery comprises:

a cathode comprising:
a first phase comprising an inorganic energy storage material;
a second phase comprising a solid state lithium ion conductor; and,
a third phase comprising a reticulated metal structure, interspersed throughout the first and second phases, the reticulated metal forming a structural reinforcement and a current collector,
wherein the metal structure comprises from 5 to 25% of the volume of material, the first and second phases together comprise from 75 to 95% of the volume of the material, and the cathode contains no more than 30 vol. % porosity;

an anode comprising a lithium storage material; and,

a lithium-conducting electrolyte separating the cathode from the anode.

According to another aspect of the invention, a lithium ion battery comprises:

an anode comprising:
a first phase comprising a lithium ion storage material;
a second phase comprising a solid state lithium ion conductor; and,
a third phase comprising a reticulated metal structure, interspersed throughout the first and second phases, the reticulated metal forming a structural reinforcement and a current collector,
wherein the metal structure comprises from 5 to 25% of the volume of material, the first and second phases together comprise from 75 to 95% of the volume of the material, and the anode contains no more than 30 vol. % porosity;

a cathode comprising an energy storage material; and,

a lithium-conducting electrolyte separating the cathode from the anode.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 illustrates schematically a vertical section of a GELSPEED deposition chamber in accordance with one aspect of the present invention.

FIG. 2A illustrates the steps for fabricating a composite electrode in accordance with one aspect of the invention.

FIG. 2B illustrates a cross-sectional SEM image of a self supporting composite LiCoO₂:Al cathode in accordance with one aspect of the invention.

FIG. 3 illustrates the steps for fabricating a solid state Li ion cell using a self supporting composite electrode in accordance with another aspect of the invention.

FIG. 4 illustrates the steps for fabricating a solid state Li ion cell using self supporting composite anode and cathode in accordance with another aspect of the invention.

FIG. 5 illustrates the steps for fabricating a solid state Li ion cell using a self supporting composite cathode with a buffer layer in accordance with another aspect of the invention.

FIG. 6 illustrates the steps for fabricating a solid state Li ion cell using self supporting composite anode and cathode with a buffer layer in accordance with another aspect of the invention.

FIG. 7A illustrates the steps for fabricating a hybrid cell using a self supporting composite cathode in accordance with one aspect of the invention.

FIG. 7B illustrates the discharge capacity of the cell of FIG. 7A having self supporting LiCoO₂:Al composite as the cathode and Li foil as the anode.

FIG. 8 illustrates the steps for fabricating a hybrid cell using self supporting composite anode and cathode with a buffer layer in accordance with another aspect of the invention.

### DETAILED DESCRIPTION OF THE INVENTION

The invention includes an industrially scalable method of fabricating a composite cathode suitable for both liquid cell and all-solid-state cell applications. The cathode consists of inorganic nanoparticles for energy storage, lithium ion conduction, and electron conduction in a metallic foam framework, which acts as a current collector and a supplementary electron conducting path, and bound together by a lithium ion conducting inorganic film.

The fabrication of multiphase electrodes may be generally summarized as follows:

Preparing the precursor sol that consists of energy storage material nuclei (first phase), the gelling agent that also act as nano-particles capping material, binder, and lithium ion conductor (second phase-A).

Adding to this slurry preformed nanoparticles of complementary lithium ion conductor (second phase-B); then adding preformed nano-particles of complementary electron conductor (third phase-B). The final precursor slurry is then formed by sonicating the mixed materials for complete homogenization.

Heated metallic foam is then populated with the final precursor slurry using any of various gel coating techniques, preferably “gel phase spray process for electroless electrochemical deposition” (GELSPEED). After baking, curing, calendaring, and final temperature anneal, the metallic foam acts as a three-dimensional support for the electrode material nanoparticles and other supporting phases, and as a stress suppressor, electron conductor, and current collector (third phase-A).

The precursor solvent is preferably deionized water. The energy storage material reagents are preferably water soluble metallic salts of Co, Ni, Mn, Fe, Al, Li, Cu, Mo, etc. as the metal ion source; urea, or thiourea as ligand and oxygen or sulfur source; phosphoric acid as the source of phosphorus; and nitric acid, sulfuric acid, triethanolamine, acetic acid, or citric acid as additional ligand. The lithium metal oxide, sulfide, or phosphate, or the metal oxide, or sulfide may also be used instead of soluble metallic salt. These reagents are dissolved in deionized water and heated at temperature ranging between 80 to 100° C. to form the nuclei of the energy storage material. The nuclei are typically about 10 nm to 5 μm in diameter. Lithium polysilicate solution, (Li₂O)ₓ(SiO₂)_{y}, where x/y is 1 to 10, is then added to the energy storage nuclei sol as a capping phase to arrest further crystal growth and transform the solution into a more gelatinous slurry. The lithium polysilicate phase typically amounts to about 1 to 10% of the electrolyte material. Preformed nanoparticles of a lithium ion conductor such as Li₂WO₄, Li_{1.3}Al_{0.3}Ti_{1.7}(PO₄)₃, Li₃PO₄, Li₂MoO₄, or Li₆La₃Zr₂O₁₂ are added to the gel. Preformed nanoparticles of an electronic conductor like carbon nanotubes, TiOₓ, nickel, tungsten, tin, Cu, or CuO, etc., are also added to the gel. These particles are preferably 10 to 100 nm in size and amount to about 1 to 30 wt. % of the electrode material. This mixture is then sonicated at 5 kHz to 1 MHz for about 5 to 20 minutes to form a homogeneous slurry with viscosity ranging from 100 to 10,000 cP. (It will be appreciated that the slurry is non-Newtonian, and further that the slurry will become more gel-like over time as the lithium polysilicate continues to polymerize, so the prepared slurry is preferably used promptly upon completion of the sonication step.) Heated metallic foam such as Ni foam, stainless steel foam, Cu foam, or aluminum foam, etc, is then populated with the slurry (typically dispensed at about 15 to 30° C.) using GELSPEED. The resulting solidified gel in the metallic foam is then baked at a temperature ranging between 100 to 200° C. This is followed by curing at temperature ranging between 250 to 400° C. to transform the energy storage material nuclei into nanoparticles. The new structure is then calendared to form a thick, 3-D electrode consisting of energy storage nanoparticles, lithium ion conducting nanoparticles, electronic conducting nanoparticles, with lithium polysilicate binding the nanoparticles to each other and to the metallic foam. Applicants have discovered, surprisingly, that in the inventive structure the metallic foam serves as an effective structural electrode support, electronic conductor, and current collector. The 3-D electrode is then annealed at temperature ranging between 300 to 800° C. so that the energy storage nanoparticles can form the desired material phase necessary for optimum lithium ion intercalation.

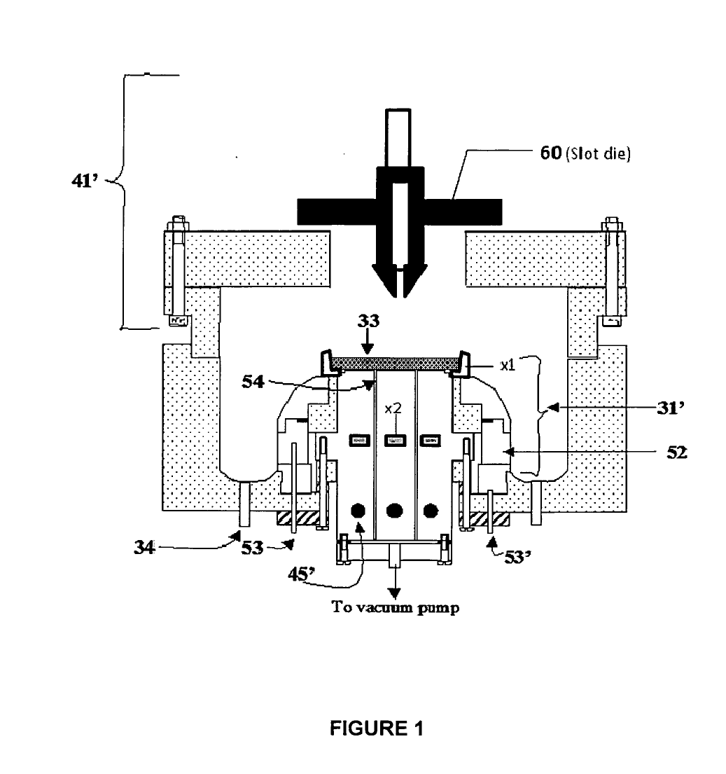

The GELSPEED process of the present invention is a variation of VPSPEED described in Applicant's U.S. Pat. No. 7,972,899, the entire disclosure of which is incorporated herein by reference. For the GELSPEED process, the nebulizer of the shower is replaced with a slot die. The slot die allows the dispensing of viscous fluids and slurries, which yields a much higher growth rate (typically more than 50 μm/minute). FIG. 1 illustrates a vertical section of a GELSPEED chamber 10 that includes a substrate holder assembly 31′ to secure substrate (workpiece) 33 and a showerhead 41′ for supplying and distributing processing solution over substrate 33. The substrate holder assembly 31′ has two substrate chucking mechanisms: the one provided by the vacuum orifices 54, and the other provided by the magnetic pellet X2. It is contemplated that in many cases the metallic foam substrate is magnetic; at the onset of the deposition the X2 is used to chuck the substrate as the vacuum cannot be used to secure a porous substrate. Once the foam is loaded and the deposited material is cured, the vacuum chuck is turned on to hold down the substrate and to help pull a fresh gel coating solution into available pores of the coated substrate. The ring structure X1 is used to impound the fluid and to provide the seal when the vacuum chuck is activated. The showerhead assembly 41′ includes a slot die 60, which is preferably movable to some degree, configured to deliver a viscous reagent gel to substrate 33. The slot die may be of various designs. One suitable type is that manufactured by Innovative Machine Corporation. The width of the slot size is about the size of the substrate to be coated. The coating uniformity is determined by the fluid delivery pressure (typically 1 to 50 psi) and the slot die opening (0.0005″ to 0.005″). The system comes with a controller that controls the deposition cycles, the temperature of the substrate holder during the deposition (100 to 150° C.), baking (100 to 200° C.), and curing (150 to 250° C.). Bake and cure times are preferably in the range of 1 to 30 minutes and 5 to 30 minutes, respectively. Additional curing at temperatures higher than 250° C. is carried out ex-situ. The chamber may further include a drain line 34 which is part of the return subsystem that directs partially spent processing solution from the chamber 10 to a reservoir (not shown). 45′ is the heat cartridge, the source of heat in the substrate holder assembly 31′. 52 is the cooling jacket with 53 as the coolant liquid inlet and 53′ coolant liquid outlet.

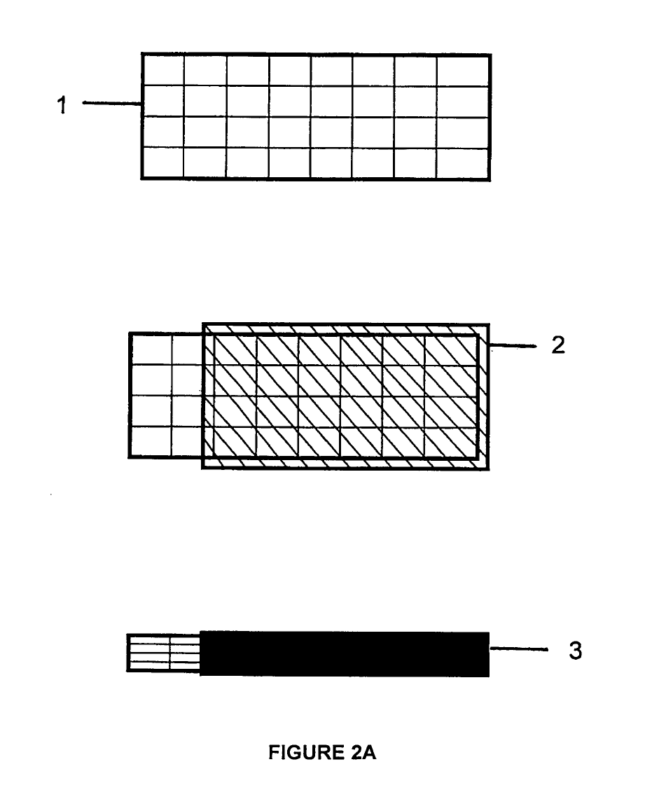

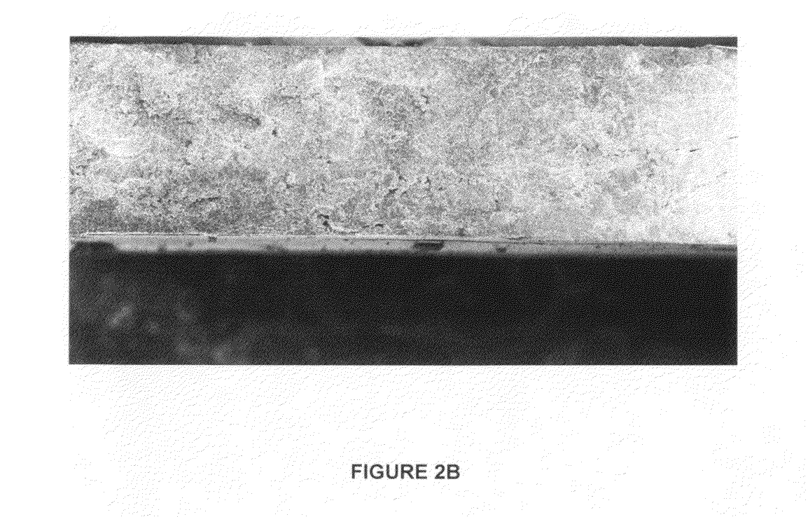

Process steps to fabricate a composite electrode are illustrated generally in FIG. 2. Beginning with a heated metallic foam preform (top), a portion of the foam is loaded with electrode materials in the form of a gel (center). After heat treatment, calendaring, and annealing, the composite electrode, supported by the metallic foam, is formed (bottom). The calendaring step compresses the composite so the final electrode is thinner and denser, as indicated schematically in the drawing. The Examples that follow will illustrate the use of the invention to make various composite structures and compositions. Those skilled in the art may easily modify the process recipes through routine experimentation in order to create electrodes for particular applications.

### EXAMPLE 1

To form a LiCoO₂:Al composite cathode, 9.0 g cobalt nitrate, 3 g urea, 1.0 g Al(NO₃)₃, and 3.0 g Li(NO₃) were dissolved in 50 ml of de-ionized water and heated until the CoAlLi[complex]O nuclei is formed and the hot solution is 20 ml. 5 ml of 1M citric acid was then added. This was followed by 1 ml of 40 wt. % lithium polysilicate in deionized water. The mixture was then sonicated to form a gel. Then, 0.3 g of Li_{1.3}Al_{0.3}Ti_{1.7}(PO₄)₃ and 0.3 g of TiOₓ nanoparticles were added for improved ionic conductivity and electronic conductivity respectively. The gel was then resonicated to homogenize the gel. The GELSPEED process was then used to populate a 3″×3″ Ni foam substrate 1 heated at 150° C. The coated foam 2 was cured at 250° C. for about 5 minutes. Coating and curing were repeated 2 more times. Additional curing was done in a box furnace at 300° C. for 10 minutes. This was followed by calendaring under a 100 ton press to compact and densify the self supporting composite LiCoO₂:Al cathode 3. Estimated pressure applied to the composite was 500 to 5000 kg/cm². The formed structure was then annealed in Argon at 500° C. for 10 minutes to complete the process. A cross-sectional SEM image of a self supporting composite LiCoO₂:Al cathode is shown in FIG. 2B. Note that comparable results can also be obtained by replacing cobalt nitrate in the formulation with 3 g LiCoO₂ nanoparticles, while reducing the LiNO₃ to 0.1 g, and urea to 0.3 g.

### EXAMPLE 2

To form a CuS composite cathode, 5 g copper nitrate, 5 g thiourea, and 4 ml hydrazine monohydrate were dissolved in 50 ml de-ionized water and heated until the Cu[complex]S nuclei was formed and the hot solution was 20 ml. 4 ml of 1M acetic acid was then added. This was followed by 1 ml of 40 wt. % lithium polysilicate in deionized water. The mixture was then sonicated to form a gel. Then, 0.3 g Li_{1.3}Al_{0.3}Ti_{1.7}(PO₄)₃ and 0.3 g TiOx nanoparticles were added for improved ionic conductivity and electronic conductivity respectively. The gel was then resonicated to homogenize the gel. The GELSPEED process was then used to populate a 3″×3″ Ni foam substrate heated at 150° C. The coated foam was cured at 200° C. for about 5 minutes. Coating and curing were repeated 2 more times. Additional curing was done in the tube furnace at 300° C. for 10 minutes in sulfur ambient. This was followed by calendaring under a 100 ton press to compact and densify the self supporting composite CuS cathode. The formed structure was then annealed in sulfur at 400° C. for 10 minutes to complete the process.

### EXAMPLE 3

To prepare a SnO composite anode, 5 g tin ethoxide, 0.4 g urea, 0.5 g Al(NO₃)₃, and 0.3 g Li(NO₃) were dissolved in 50 ml of de-ionized water and heated until the SnAlLi[complex]O nuclei was formed and the hot solution is 20 ml. 4 ml of 1M acetic acid was then added. This was followed by 1 ml of 40 wt. % lithium polysilicate in deionized water. The mixture was then sonicated to form a gel. Then, 0.3 g Li_{1.3}Al_{0.3}Ti_{1.7}(PO₄)₃ and 0.3 g TiOₓ nanoparticles were added for improved ionic conductivity and electronic conductivity respectively. The gel was then resonicated to homogenize the gel. The GELSPEED process was then used to populate a 3″×3″ Ni foam substrate heated at 150° C. The coated foam was cured at 250° C. for about 5 minutes. Coating and curing were repeated 2 more times. Additional curing was done in a box furnace at 300° C. for 10 minutes. This was followed by calendaring under a 100 ton press to compact and densify the self supporting composite SnO anode. The formed structure was then annealed in argon at 500° C. for 10 minutes to complete the process.

In addition to the exemplary compositions in the preceding examples, other electrode compositions and reagents may easily be substituted according to the inventive method. The list of other cathodes includes LiMn_{y}Oₓ, where x is 2 or 4 and y is 1 or 2; LiFePO₄; LiMnPO₄; LiMn₍₁₋ₓ₎FeₓPO₄; LiNiO₂; LiMn_{(1-x-y-z)}NiₓCo_{y}Al_{z}O₂; TiS; MoS; FeS, and CuMS, where M is Fe, Zn, Sn, Ti, or Mo. The list of other anodes includes SnOₓ; SnSₓ; Li₄Ti₅O₁₂; LiCₓ; MnOₓ; and CoOₓ. The precursors of the constituting elements of these compounds are any water soluble compounds of these elements. The precursors may alternatively be non water soluble nanoparticles of these compounds. Preferred ligands are urea for the oxides, thiourea for the sulfides, and phosphoric acid for the phosphates. Other complimentary ligands include acetic acid, citric acid, oxalic acid, nitric acid, triethanolamine, and hydrazine. The lithium ion and electronic conducting additives include Li₂WO₄, Li_{1.3}Al_{0.3}Ti_{1.7}(PO₄)₃, Ohara glass®, LiAlGaPO₄, Li₇₋ₓLa₃(Zr₂₋ₓNbₓ)O₁₂, LiLaTiO, LiLaZrO, Ti₄O₇ (Ebonex® ceramic), Li₂WO₄, Li₂MoO₄ carbon nanotube, carbon nanowire, carbon nano-particles, semiconductor nanowire, semiconductor nano-particles, metal nanowire, metal nano-particles and ceramic nano-particles.

Some specific electrode materials include the following:
LiMn₂₋ₓM1ₓO₄ where M1 is selected from the group comprising Al, Sn, Zn, and Fe, and 0≦x≦0.05;
LiCo₁₋ₓM2ₓO₂ where M2 is selected from the group comprising Ni and Al, and 0≦x≦0.5;
LiNi₁₋ₓM3ₓO₂ where M3 is selected from the group comprising Co and Al, and 0≦x≦0.5;
LiMnₓNi_{y}Co_{z}AlₜO₂ where x+y+z+t=1, and 0≦(x, y, z, and t)≦1;
LiM4PO₄, where M4 is selected from the group comprising Fe, Co, Ni, and Mn;
CuS, or CuM5S where M5 is selected from the group comprising Fe, Sn, Mo, and Zn; LiFePO₄; Li₄Ti₅O₁₂; FeS; and MoS.

It will be understood by those skilled in the art that the atmosphere used in the various heat treatments, particularly the final high-temperature anneal, will be dictated by the type of electrode being formed and therefore may be oxidizing, reducing, or inert. Oxidizing atmospheres may include air or oxygen at a selected pressure, whereas reducing atmospheres may include hydrogen, natural gas, carbon monoxide, methane, etc. Inert atmospheres include nitrogen and argon.

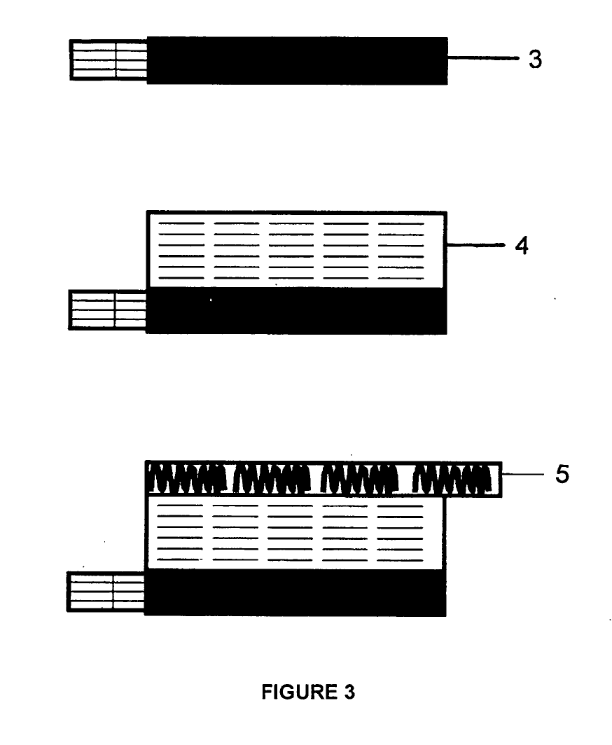

Process steps to fabricate an inorganic solid state lithium ion cell using the self supporting composite cathode are illustrated generally in FIG. 3. Beginning with a self supporting cathode made according to the process shown in FIG. 2, a high alkali metal (preferably lithium) ion conducting solid state electrolyte [for example, Li_{y}Al₍₁₋ₓ₎GaₓS(PO₄)] is deposited as a layer by VPSPEED or other suitable process. The Li anode and current collector is then deposited on top of the electrolyte by evaporation or other suitable method, thereby forming a Li cell (bottom).

### EXAMPLE 4

To fabricate a LiCoO₂:Al solid state cell, the self supporting composite LiCoO₂:Al cathode 3 as prepared in Example 1 was used. About 4 μm thick Li_{y}Al₍₁₋ₓ₎GaₓS(PO₄) solid state electrolyte 4 was then deposited and processed on the cathode 3 as described in Applicant's U.S. Pat. Appl. Pub. 2011/0168327, the entire disclosure of which is incorporated herein by reference. This was followed by the deposition of 2 μm thick Li 5 by Field-Assisted VPSPEED (FAVPSPEED), described in detail in Applicant's U.S. Pat. Appl. Pub. 2011/0171398, the entire disclosure of which is incorporated herein by reference. (It may alternatively be deposited using a traditional vacuum technique.) 50 μm thick Li foil was then hot laminated onto the 2 μm deposited Li for current collection to complete the cell.

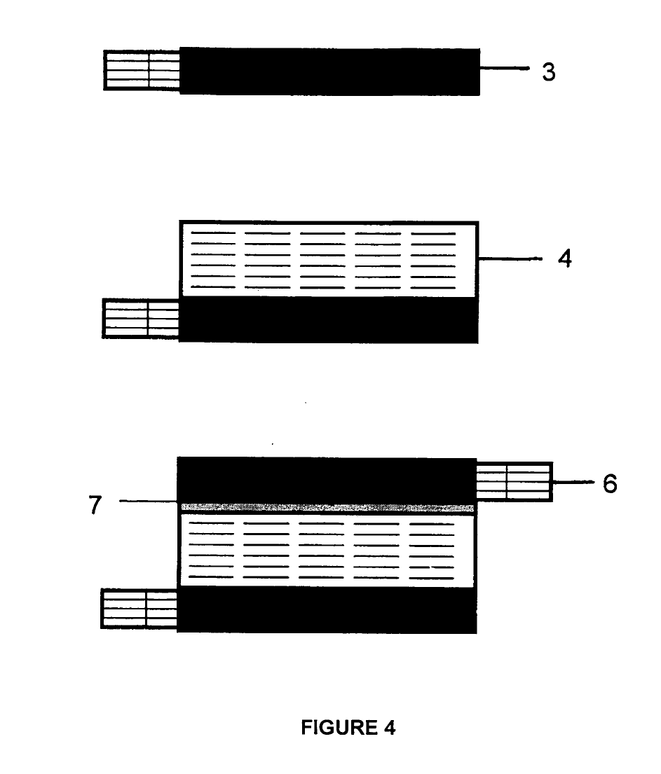

Process steps to fabricate an inorganic solid state lithium ion cell using both a self supporting composite cathode and a self supporting composite anode are illustrated generally in FIG. 4. Beginning with a self supporting cathode 3 (top) made according to the process shown in FIG. 2, a solid state electrolyte 4 [for example, Li_{y}Al₍₁₋ₓ₎GaₓS(PO₄)] is deposited as a layer by VPSPEED or other suitable process (center). A self supporting composite anode and current collector 6 is then attached to the electrolyte using lithium ion conducting glue 7, thereby forming a Li cell (bottom).

### EXAMPLE 5

Both composite self supporting LiCoO₂:Al cathode and Li_{y}Al₍₁₋ₓ₎GaₓS(PO₄) solid state electrolyte are deposited and processed as described in EXAMPLE 4. A 5 μm thick lithium ion conducting glue consisting of 6 g polyvinylidene fluoride (PVDF) dissolved in 40 g dimethoxyethane (DME) solvent, 15 g 2M 3M™ Fluorad™ (lithium(bis)trifluoromethanesulfonimide) dissolved in Tetrahydrofuran (THF), with 4 g Ohara glass nano-particles is then spray deposited by VPSPEED on the solid state electrolyte. The self supporting SnO anode of EXAMPLE 3 is then hot pressed on the glue at 120° C. to complete the cell fabrication.

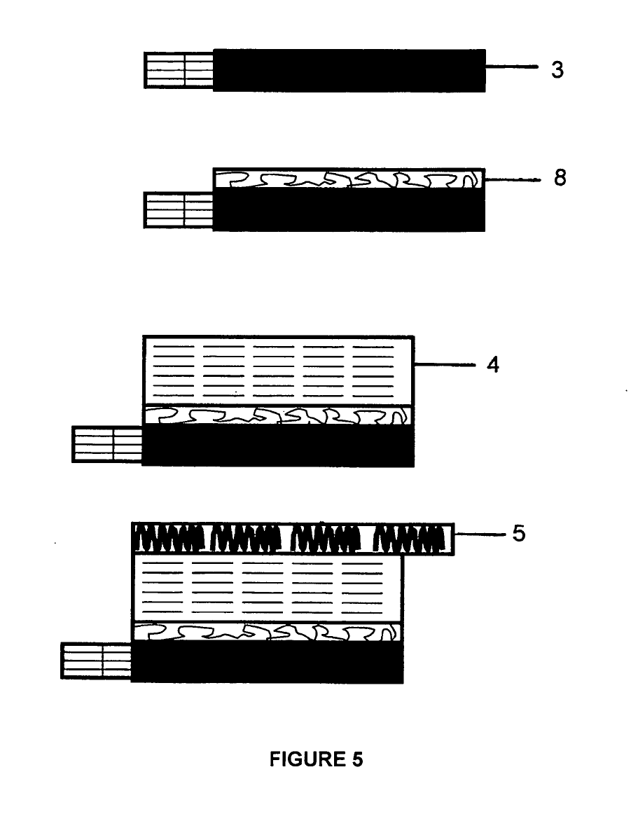

Process steps to fabricate an inorganic solid state lithium ion cell using a self supporting composite cathode with a buffer layer are illustrated generally in FIG. 5. Beginning with a self supporting cathode 3 (top) made according to the process shown in FIG. 2, a buffer layer 8 (for example, LiNbO₃) is deposited by VPSPEED on the cathode. This buffer layer serves to reduce the internal resistance of the cell caused by lattice mismatch and built in field between cathode and electrolyte. Next, a solid state electrolyte 4 [for example, Li_{y}Al₍₁₋ₓ₎GaₓS(PO₄)] is deposited as a layer by VPSPEED or other suitable process. The Li anode and current collector 5 is then deposited on top of the electrolyte by evaporation or other suitable method, thereby forming a Li cell (bottom).

### EXAMPLE 6

The LiCoO₂:Al solid cell with a buffer layer construct is same as that of EXAMPLE 4; except that a 0.05 μm thick LiNbO₃ is deposited on LiCoO₂:Al as a buffer layer before the deposition of Li_{y}Al₍₁₋ₓ₎GaₓS(PO₄) solid state electrolyte. The aqueous solution of LiNbO₃ consisting of lithium nitrate 0.1M, niobium nitrate 0.1M, urea 0.2M, nitric acid 0.05M, and 5% volume alcohol is spray deposited by VPSPEED at 250° C., followed by annealing in Ar at 500° C. for about 10 minutes.

Those skilled in the art will appreciate that other materials may be suitable for the buffer layer in particular applications. Some suitable materials include: LiNbO₃, LiₓSiO_{y}, Li-βAl₂O₃, LiₓAlSiO_{y}, Li_{1.3}Al_{0.3}Ti_{1.7}(PO₄)₃, Li₇₋ₓLa₃(Zr₂₋ₓNbₓ)O₁₂, Li_{y}Al₍₁₋ₓ₎GaₓS(PO₄), Li_{0.35}La_{0.55}TiO₃, and LiTi₂(PO₄)₃.

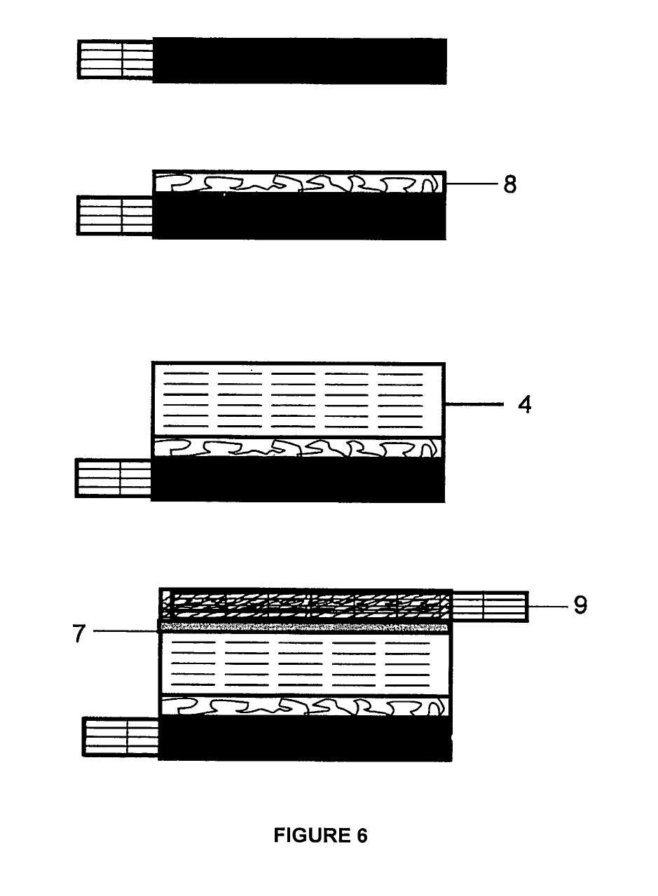

Process steps to fabricate an inorganic solid state lithium ion cell using both a self supporting composite cathode and a self supporting composite anode, and a buffer layer are illustrated generally in FIG. 6. Beginning with a self supporting cathode (top) made according to the process shown in FIG. 2, a buffer layer (e.g., LiNbO₃) is deposited on the cathode as described in EXAMPLE 6. Again, this buffer layer serves to reduce the internal resistance of the cell caused by lattice mismatch and built in field between cathode and electrolyte. A solid state electrolyte [for example, Li_{y}Al₍₁₋ₓ₎GaₓS(PO₄)] is deposited on top of the buffer layer by VPSPEED or other suitable process. A self supporting composite anode and current collector is then attached to the electrolyte using lithium ion conducting glue, thereby forming a Li cell (bottom).

### EXAMPLE 7

The LiCoO₂:Al solid cell with a buffer layer construct is the same as that of EXAMPLE 6. Next a lithium ion conducting glue layer described in EXAMPLE 5 is deposited on the solid electrolyte. The self supporting SnO anode of EXAMPLE 3 is then hot pressed on the glue at 120° C. to complete the cell fabrication.

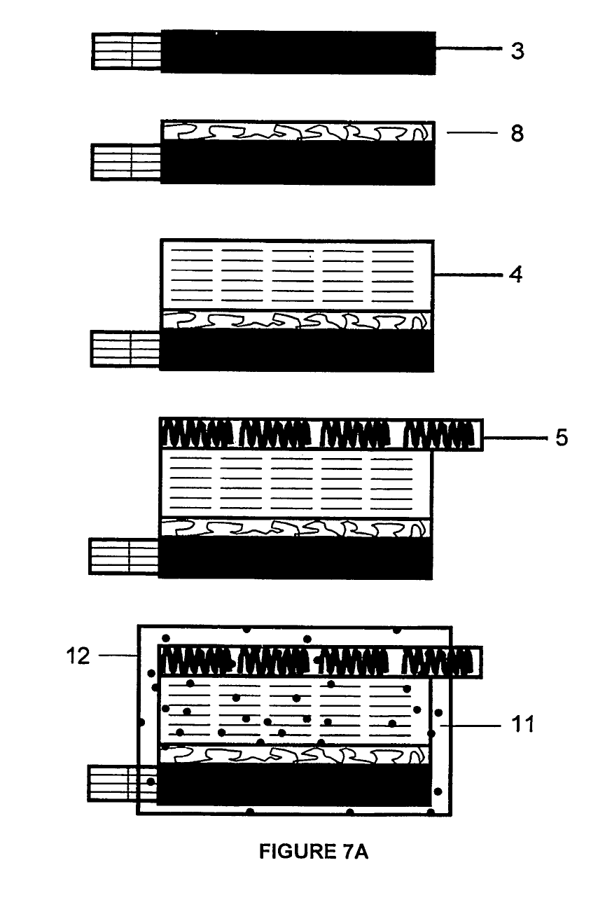

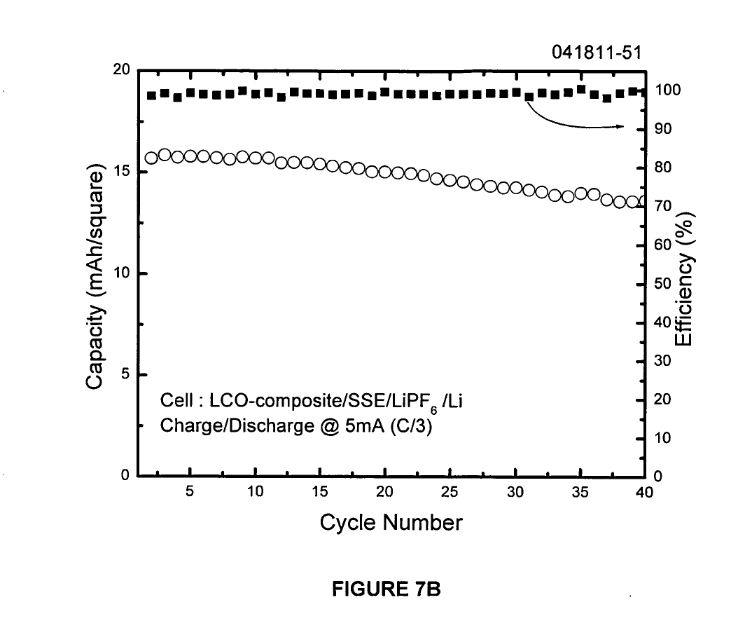

Process steps to fabricate a hybrid lithium ion cell using a self supporting composite cathode and a buffer layer are illustrated generally in FIG. 7. Beginning with a self supporting cathode 3 (top) made according to the process shown in FIG. 2, a buffer layer 8 (e.g., LiNbO₃) described in Example 6 is deposited as previously described on the cathode. A solid state electrolyte 4 [for example, Li_{y}Al₍₁₋ₓ₎GaₓS(PO₄)] is deposited on top of the buffer layer by VPSPEED or other suitable process. A lithium foil anode and current collector 5 is then placed on top of the electrolyte with or without polymer separator. Finally, the assembly is placed in a pouch 12, which is filled with liquid electrolyte 11 (for example, a LiPF₆ solution) and sealed to form the completed Li cell (bottom). The liquid electrolyte further enhances the lithium ion conduction among all components of the cell.

### EXAMPLE 8

The formation of a hybrid LiCoO₂:Al cell with a buffer layer construct is same as that of EXAMPLE 6, except that the assembly is placed in a pouch filled with liquid electrolyte. The liquid electrolyte is a 1.5M solution of LiPF₆ in 1:1 ethylene carbonate/propylene carbonate solvent. The discharge capacity of the cell, about 15 mAh/cm² at C/3, is shown in FIG. 7B. This shows minimum fade after about 40 cycles. The columbic efficiency of the cell is excellent at about 100%.

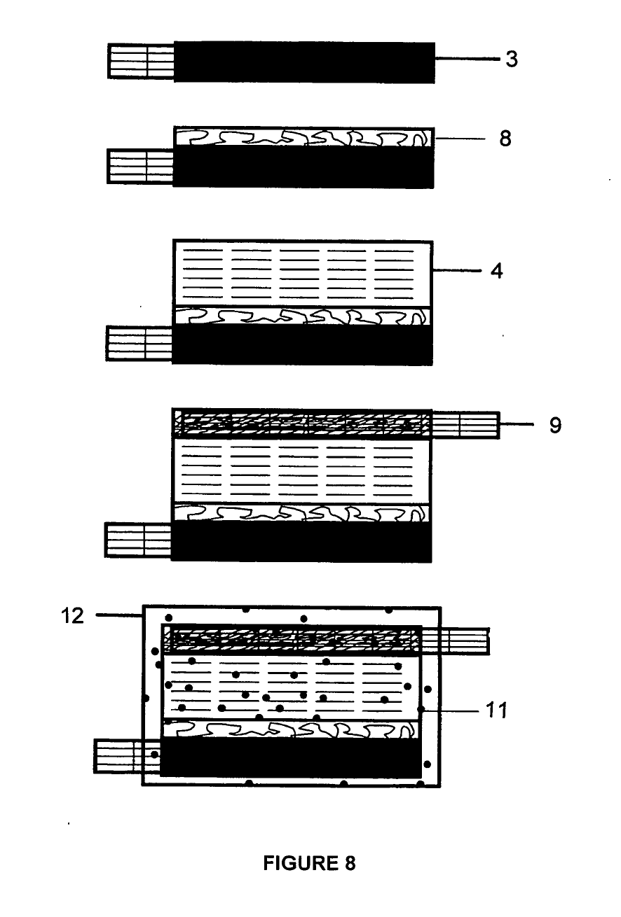

Process steps to fabricate a hybrid lithium ion cell using a self supporting composite cathode and anode, and a buffer layer, are illustrated generally in FIG. 8. Beginning with a self supporting cathode 3 (top) made according to the process shown in FIG. 2, a buffer layer 8 (e.g., LiNbO₃) is deposited as previously described on the cathode. A solid state electrolyte 4 [for example, Li_{y}Al₍₁₋ₓ₎GaₓS(PO₄)] is deposited on top of the buffer layer by VPSPEED or other suitable process. A self supporting composite anode 9 is then placed on top of the electrolyte with or without polymer separator. Finally, the assembly is placed in a pouch 12, which is filled with liquid electrolyte 11 (for example, a LiPF₆ solution) and sealed to form the completed Li cell. Again the liquid electrolyte enhances the lithium ion conduction among all components of the cell.

### EXAMPLE 9

The formation of a hybrid LiCoO₂:Al solid cell with a buffer layer construct is same as that of EXAMPLE 8, except that the lithium foil anode is replaced by the self supporting SnO anode of EXAMPLE 3.

It will be further appreciated that the inventive process yields a novel structure that exhibits many superior characteristics that make it desirable for use in various battery designs. For example, the composite structures described by Wang et al. [Journal of Power Sources 196:8714-18 (2011)] used metal foam but were not calendared because, presumably, it was considered desirable to have a substantially porous electrode structure that could be infiltrated by liquid electrolyte in order to improve the kinetics of charging and discharging. However, the structure ultimately showed a somewhat limited lifetime. The inventive, calendared electrode, despite its relatively high density, surprisingly shows excellent ionic conductivity, which is provided mostly by the inorganic binder and lithium ion conducting nanoparticle additives.

Some exemplary physical characteristics of the inventive electrode include the following: The completed cathode preferably has 5 to 25% of its volume occupied by the metal foam and 75 to 95% by the electrode active materials and other additives. Final density is preferably between 2 and 6 g/cm³. Porosity is typically between 5 and 30%. The metal is preferably Ni but may alternatively be any suitable metallic conductor, such as Al, Cu, Fe, stainless steel, etc. Although in many of the examples constructed, the substrate was metal foam having interconnected porosity, it will be appreciated that a woven or other porous fibrous metal such as steel wool may also be suitable for some applications.

Some unique attributes of the inventive structure include the following:
a. A self supporting dense cathode can be interchangeably used to fabricate inorganic solid state cells or liquid cells.
b. Ionic conductivity is provided mostly by the inorganic binder, and other inorganic ion conducting additives instead of liquid electrolyte residing in the pores of less dense traditional cathodes that have insulative organic binders.
c. Electronic conductivity is provided by a reticulated metallic wire mesh, metal wool, or metal foam and preferably inorganic electron conducting additives. The reticulated metallic phase further serves as a mechanical reinforcement for the structure.
d. The cathode thickness is typically in the range of 100 μm to 500 μm.
e. The cathode may have an inorganic solid state electrolyte or a bilayer of lithium ion conducting buffer and inorganic solid state electrolyte deposited on it.
f. The latter structure when used in a liquid cell blocks the formation of any solid-electrolyte-interface layer; this creates a cell with long cycle life and no self discharge.
g. The structure, when used in a solid state cell, can deliver energy in the mA/cm² range compared to values in the μA/cm² range commonly observed in traditional inorganic solid state cells.
h. The anodes of the inventive cells may be either an inorganic solid state electrolyte protected Li anode or another composite self supporting anode.
i. The inventive composite structure shows no Li dendrite formation and all materials making up the cell are inorganic with very high melting temperature, hence, the cells are very safe.

It will be appreciated by those skilled in the art that many variations and combinations may be constructed using the methods described in the foregoing Examples, which are provided for illustrative purposes and are not intended to limit the scope of the invention as defined by the claims that follow.

We claim:

1. A method for making a composite electrode for a lithium ion battery comprising the steps of:
preparing a slurry containing particles of a selected inorganic electrode material suspended in a selected solvent;
preheating a porous metallic substrate;
loading said preheated metallic substrate with said slurry;
baking said loaded substrate at a first selected temperature;
curing said baked substrate at a second selected temperature sufficient to form a desired nanocrystalline material within the pores of said substrate;
calendaring the cured composite to reduce internal porosity; and,
annealing said calendared composite at a third temperature greater than said second temperature to produce a self-supporting multiphase electrode.

2. The method of claim 1 wherein said gel preparing step comprises the following steps:
preparing a precursor solution, comprising:
a solvent;
a source of at least one metallic ion;
at least two ligands, and,
a source of at least one species selected from the group consisting of: oxygen, sulfur, and phosphorus;
heating said precursor solution to form nuclei of a first phase;
adding a second solution containing a second phase to form a first slurry comprising nuclei of said first phase capped by said second phase;
adding preformed nanoparticles of at least one additional selected phase to said first slurry; and,
sonicating the resulting mixture to form a homogeneous final slurry suitable for dispensing onto a substrate.

3. The method of claim 2 wherein said source of at least one metallic ion comprises a soluble salt of a metal selected from the group consisting of: Co, Ni, Mn, Fe, Al, Li, Cu, and Mo.

4. The method of claim 2 wherein said at least two ligands are selected from the group consisting of: urea, thiourea, nitric acid, sulfuric acid, triethanolamine, acetic acid, and citric acid.

5. The method of claim 2 wherein the heating of said solution is performed at a temperature in the range of about 80 to 100° C. to form said nuclei.

6. The method of claim 2 wherein said nuclei are about 10 nm to 5 μm in size.

7. The method of claim 2 wherein said second solution comprises lithium polysilicate, (Li₂O)ₓ(SiO₂)_{y}, where x/y is 1 to 10.

8. The method of claim 2 wherein said preformed nanoparticles comprise at least one material selected from the group consisting of: Li₂WO₄, Li_{1.3}Al_{0.3}Ti_{1.7}(PO₄)₃, Ohara glass®, LiAlGaPO₄, Li₇₋ₓLa₃(Zr₂₋ₓNbₓ)O₁₂, LiLaTiO, LiLaZrO, Ti₄O₇ (Ebonex® ceramic), carbon nanotube, carbon nanowire, carbon nano-particles, semiconductor nanowire, semiconductor nano-particles, metal nanowire, metal nano-particles and ceramic nano-particles.

9. The method of claim 8 wherein said nanoparticles are in the range of 10 to 100 nm in size and represent about 1 to 30% by weight of the electrode material.

10. The method of claim 2 wherein said homogeneous slurry has a viscosity from about 100 to 10,000 cP.

11. The method of claim 1 wherein said substrate comprises metal foam selected from the group consisting of: Ni and Ni alloys, stainless steel, Cu and Cu alloys, Al and Al alloys.

12. The method of claim 1 wherein said metallic substrate is preheated to a temperature in the range of about 50 to 150° C.

13. The method of claim 1 wherein said loading step comprises spraying said slurry at a temperature of about 15 to 30° C. onto said 100 to 150° C. preheated substrate at a pressure of about 5 to 50 psi.

14. The method of claim 1 wherein said baking is performed at about 100 to 200° C. for 1 to 30 minutes.

16. The method of claim 1 wherein said calendaring is performed at about 20 to 250° C. under a pressure of about 500 to 5000 kg/cm².

17. The method of claim 1 wherein said annealing is performed at about 300 to 800° C. for 5 to 60 minutes.

18. The method of claim 2 wherein said first phase comprises a compound selected from the group consisting of:
LiMn₂₋ₓM1ₓO₄ where M1 is selected from the group consisting of Al, Sn, Zn, and Fe, and 0≦x≦0.05;
LiCo₁₋ₓM2ₓO₂ where M2 is selected from the group consisting of Ni and Al, and 0≦x≦0.5;
LiNi₁₋ₓM3ₓO₂ where M3 is selected from the group consisting of Co and Al, and 0≦x≦0.5;
LiMnₓNi_{y}Co_{z}AlₜO₂ where x+y+z+t=1, and 0≦(x, y, z, and t)≦1;
LiM4PO₄, where M4 is selected from the group consisting of Fe, Co, Ni, and Mn;
CuS;
CuM5S where M5 is selected from the group consisting of Fe, Sn, Mo, and Zn;
LiFePO₄;
Li₄Ti₅O₁₂;
FeS; and,
MoS.

19. The method of claim 1 wherein said self-supporting electrode comprises 5 to 25 vol. % metal foam and 75 to 95 vol.% of the electrode active materials and other additives.

20. The method of claim 1 wherein said self-supporting electrode has a final density between 2 and 6 g/cm³ and no more than 30 vol. % porosity after calendaring and annealing.

21. The method of claim 1 wherein said composite electrode comprises a cathode material selected from the group consisting of:
CuS;
LiCoO₂:Al;
LiMn₂₋ₓM1ₓO₄ where M1 is selected from the group consisting of Al, Sn, Zn, and Fe, and 0≦x≦0.05;
LiCo₁₋ₓM2ₓO₂ where M2 is selected from the group consisting of Ni and Al, and 0≦x≦0.5;
LiNi₁₋ₓM3ₓO₂ where M3 is selected from the group consisting of Co and Al, and 0≦x≦0.5;
LiMnₓNi_{y}Co_{z}AlₜO₂ where x+y+z+t=1, and 0≦(x, y, z, and t)≦1;
LiM4PO₄, where M4 is selected from the group consisting of Fe, Co, Ni, and Mn;
CuM5S where M5 is selected from the group consisting of Fe, Sn, Mo, and Zn;
LiFePO₄; Li₄Ti₅O₁₂; FeS; and MoS,
and said method includes the additional steps of:
depositing a Li ion conductor on said cathode; and,
depositing a Li anode on said Li ion conductor, thereby forming a Li ion battery.
